(19) United States
(12) Patent Application Publication
(10) Pub. No.: US 2026/0362291 A1
(43) Pub. Date: Nov. 12, 2026

(54) METHOD AND SYSTEM FOR PROVISIONING A GATEWAY DEVICE OF A BUILDING CONTROL SYSTEM TO COMMUNICATE WITH A PLURALITY OF WIRELESS BUILDING CONTROL DEVICES OVER A WIRELESS MESH NETWORK

(71) Applicant: Honeywell International Inc., Charlotte, NC (US)

(72) Inventors: Jeetendra Mallireddy, Hyderabad (IN); Neeraja Kanteti, Hyderabad (IN); Rajani Peddineni, Hyderabad (IN); Usha Ankadi, Hyderabad (IN)

(21) Appl. No.: 19/203,686

(22) Filed: May 9, 2025

(51) Int. Cl. H04W 40/24; H04B 17/318; H04L 45/00; H04W 88/16

(52) U.S. Cl. CPC H04W 40/246; H04B 17/318; H04L 45/20; H04W 88/16

(57) ABSTRACT

A method and system for provisioning a gateway device in a building control system to communicate with wireless building control devices over a wireless mesh network. The gateway device broadcasts a discover request, receives responses from wireless devices within range, and automatically enrolls devices meeting communication path criteria as first level devices in a routing table. Enrolled first level devices then broadcast discover requests to find additional devices, which can be enrolled as second level devices if they meet criteria. This process continues through multiple levels until no more devices are discovered. The system determines and records optimal and alternative communication paths between the gateway and enrolled devices. The gateway can provide the routing table to a cloud application for device validation and digital twin creation. The wireless building control devices may include door locks, repeaters, card readers and/or any other suitable building control device.

### TECHNICAL FIELD

The present disclosure relates generally to building control systems, and more particularly to automatically provisioning a gateway device of a building control system to communicate with a plurality of wireless building control devices over a wireless mesh network.

### BACKGROUND

Building control systems can include a large number of wireless building control devices that need to be paired with a corresponding gateway device. In some cases, an installer must travel to and physically interact with each of the wireless building control devices to manually pair them with a corresponding gateway device. This can be a time-consuming and error prone process, particularly if the building control system includes a large number of wireless building control devices. What would be desirable are methods and systems for automatically provisioning a gateway device of a building control system to communicate with a plurality of wireless building control devices over a wireless mesh network.

### SUMMARY

The present disclosure relates generally to building control systems, and more particularly to automatically provisioning a gateway device of a building control system to communicate with a plurality of wireless building control devices over a wireless mesh network. An example method includes the gateway device wirelessly broadcasting a discover building control device request. One or more of the plurality of wireless building control devices that are within wireless range of the gateway device receive the discover building control device request broadcast by the gateway device. In response to receiving the discover building control device request, each of the one or more of the plurality of wireless building control devices that are within wireless range of the gateway device wireless transmit a response message back to the gateway device. The gateway device determines which of the response messages indicate a communication path between the gateway device and the respective wireless building control device that meets a first predetermined communication path criteria. The gateway device automatically enrolls each of the one or more of the plurality of wireless building control devices that transmitted a response message that indicates the communication path between the gateway device and the respective wireless building control device meets the first predetermined communication path criteria. The enrollment of the each of the one or more of the plurality of wireless building control devices are recorded with the gateway device as enrolled first level wireless building control device in a routing table maintained by the gateway device.

The gateway device then sends a discover command to each of the enrolled first level wireless building control devices, wherein the discover command causes each of the enrolled first level wireless building control devices to wirelessly broadcast a discover building control device request. Each of the plurality of wireless building control devices that are within wireless range of a respective enrolled first level wireless building control device receive the discover building control device request, and in response, transmit a response message back to the respective enrolled first level wireless building control device. The respective enrolled first level wireless building control device receives the response message transmitted by each of the plurality of wireless building control devices that are within wireless range of the respective enrolled first level wireless building control device. The respective enrolled first level wireless building control device determines which of the response messages transmitted by each of the plurality of wireless building control devices indicate a communication path between the respective enrolled first level wireless building control device and the respective wireless building control device that meets a second predetermined communication path criteria. The respective enrolled first level wireless building control device automatically enrolls each of the one or more of the plurality of wireless building control devices that transmitted a response message that indicates the communication path between the respective enrolled first level wireless building control device and the respective wireless building control device meets the second predetermined communication path criteria. The enrollment of the each of the one or more of the plurality of wireless building control devices is recorded with the respective enrolled first level wireless building control device as enrolled second level wireless building control device in the routing table maintained by the gateway device.

Another example may be found in a building control system. The building control system includes a gateway device and a plurality of wireless building control devices. The gateway device is configured to broadcast a discover building control device request. Each of one or more of the plurality of wireless building control devices that are within wireless range of the gateway device are configured to receive the discover building control device request broadcast by the gateway device. In response to receiving the discover building control device request, each of the one or more of the plurality of wireless building control devices that are within wireless range of the gateway device wireless are configured to transmit a response message back to the gateway device. The gateway device is configured to determine which of the response messages indicate a communication path between the gateway device and the respective wireless building control device that meets a first predetermined communication path criteria. The gateway device is configured to automatically enroll each of the one or more of the plurality of wireless building control devices that transmitted a response message that indicates the communication path between the gateway device and the respective wireless building control device meets the first predetermined communication path criteria. The gateway device is configured to record the enrollment of the each of the one or more of the plurality of wireless building control devices with the gateway device as enrolled first level wireless building control device in a routing table maintained by the gateway device.

The gateway device is configured to send a discover command to each of the enrolled first level wireless building control devices, wherein the discover command causes each of the enrolled first level wireless building control devices to wirelessly broadcast a discover building control device request. Each of the plurality of wireless building control devices that are within wireless range of a respective enrolled first level wireless building control device are configured to receive the discover building control device request, and in response, transmit a response message back to the respective enrolled first level wireless building control device. The respective enrolled first level wireless building control device is configured to receive the response message transmitted by each of the plurality of wireless building control devices that are within wireless range of the respective enrolled first level wireless building control device. The respective enrolled first level wireless building control device is configured to determine which of the response messages transmitted by each of the plurality of wireless building control devices indicate a communication path between the respective enrolled first level wireless building control device and the respective wireless building control device that meets a second predetermined communication path criteria. The respective enrolled first level wireless building control device is configured to automatically enroll each of the one or more of the plurality of wireless building control devices that transmitted a response message that indicates the communication path between the respective enrolled first level wireless building control device and the respective wireless building control device meets the second predetermined communication path criteria. The gateway device is configured to record the enrollment of the each of the one or more of the plurality of wireless building control devices with the respective enrolled first level wireless building control device as enrolled second level wireless building control device in the routing table maintained by the gateway device.

Another example may be found in a method for provisioning a gateway device of a building control system to communicate with a plurality of wireless building control devices over a wireless mesh network. The illustrative method includes the gateway device wirelessly broadcasting a discover building control device request. One or more of the plurality of wireless building control devices that are within wireless range of the gateway device receive the discover building control device request broadcast by the gateway device. In response to receiving the discover building control device request, each of the one or more of the plurality of wireless building control devices that are within wireless range of the gateway device wireless transmit a response message back to the gateway device. The gateway device determines which of the response messages indicate a communication path between the gateway device and the respective wireless building control device that meets a first predetermined communication path criteria. The gateway device automatically enrolls each of the one or more of the plurality of wireless building control devices that transmitted a response message that indicates the communication path between the gateway device and the respective wireless building control device meets the first predetermined communication path criteria. The enrollment of the each of the one or more of the plurality of wireless building control devices is recorded with the gateway device as enrolled first level wireless building control device in a routing table maintained by the gateway device.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative system;

FIG. 2 is a schematic block diagram showing an illustrative workflow within an illustrative system;

FIGS. 3A, 3B, 3C, 3D, and 3E are flow diagrams that together show an illustrative method for provisioning a gateway device of a building control system; and

FIGS. 4A, 4B, and 4C are flow diagrams that together show an illustrative method for provisioning a gateway device of a building control system.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

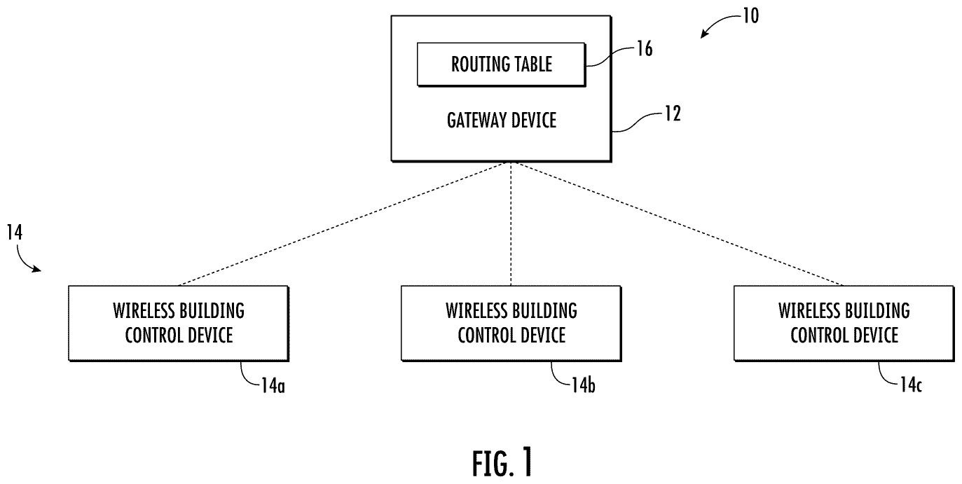

FIG. 1 is a schematic block diagram showing an illustrative system 10. The illustrative system 10 includes a gateway device 12 and a plurality of wireless building control devices 14, individually labeled as 14a, 14b, and 14c. The gateway device 12 and the plurality of wireless building control devices 14 may communicate over a wireless mesh network, for example. The wireless building control devices 14 may include wireless building control devices that will be identified as first level wireless building control devices 14. The wireless building control devices 14 may include wireless building control devices 14 that will be identified as second level wireless building control devices 14. Third, fourth and higher level wireless building control devices 14 may be included. First level wireless building control devices 14 are those that are able to wirelessly communicate well with the gateway device 12. Second level wireless building control devices 14 are those that may not be able to wirelessly communicate well with the gateway device 12, but are able to wirelessly communicate well with one or more of the first level wireless building control devices 14. Third level wireless building control devices 14 are those that may not be able to wirelessly communicate well with the gateway device 12 or any of the first level wireless building control devices 14, but are able to wirelessly communicate well with one or more of the second level wireless building control devices 14. Wireless communication quality may be based on a predetermined communication path criteria. Examples include one or more of a Received Signal Strength Indicator (R SSI) that is above a first signal strength threshold, a message transmit time of less than a first transit time threshold, and a hop count below a hop count threshold. In some cases, the predetermined communication path criteria may include an angle of arrival of a wireless signal corresponding to the response message. These are just examples.

While a total of three wireless building control devices 14 are shown, it will be appreciated that the system 10 may include considerably more than three wireless building control devices 14. Some of the wireless building control devices 14 may include wireless door locks. Some of the wireless building control devices 14 may include card readers. Some of the wireless building control devices 14 may include wireless thermostats and/or other building control device. Some of the wireless building control devices 14 may include sensors, such as temperature sensors, humidity sensors, motion sensors, glass break sensors, smoke sensors, microphones and/or any other suitable sensor. Some of the wireless building control devices 14 may include wireless repeaters.

The gateway device 12 is configured to broadcast a discover building control device request. Each of one or more of the plurality of wireless building control devices 14 that are within wireless range of the gateway device 12 are configured to receive the discover building control device request broadcast by the gateway device 12. In response to receiving the discover building control device request, each of the one or more of the plurality of wireless building control devices 14 that are within wireless range of the gateway device 12 are configured to transmit a response message back to the gateway device 12.

The gateway device 12 is configured to determine which of the response messages indicate a communication path between the gateway device 12 and the respective wireless building control device 14 that meets a first predetermined communication path criteria. The gateway device 12 is configured to automatically enroll each of the one or more of the plurality of wireless building control devices 14 that transmitted a response message that indicates the communication path between the gateway device 12 and the respective wireless building control device 14 meets the first predetermined communication path criteria. The gateway device 12 is configured to record the enrollment of the each of the one or more of the plurality of wireless building control devices 14 with the gateway device 12 as enrolled first level wireless building control device in a routing table 16 that is maintained by the gateway device 12. This starts to automatically provision the system 10 and the accompanying wireless mesh network.

The gateway device 12 is configured to send a discover command to each of the enrolled first level wireless building control devices 14, wherein the discover command causes each of the enrolled first level wireless building control devices 14 to wirelessly broadcast a discover building control device request. Each of the plurality of wireless building control devices 14 that are within wireless range of a respective enrolled first level wireless building control device 14 are configured to receive the discover building control device request, and in response, transmit a response message back to the respective enrolled first level wireless building control device 14. The respective enrolled first level wireless building control device 14 is configured to receive the response message transmitted by each of the plurality of wireless building control devices 14 that are within wireless range of the respective enrolled first level wireless building control device 14. The respective enrolled first level wireless building control device 14 is configured to determine which of the response messages transmitted by each of the plurality of wireless building control devices 14 indicate a communication path between the respective enrolled first level wireless building control device 14 and the respective wireless building control device 14 that meets a second predetermined communication path criteria. The respective enrolled first level wireless building control device 14 is configured to automatically enroll each of the one or more of the plurality of wireless building control devices 14 that transmitted a response message that indicates the communication path between the respective enrolled first level wireless building control device 14 and the respective wireless building control device 14 meets the second predetermined communication path criteria. The gateway device 12 is configured to record the enrollment of the each of the one or more of the plurality of wireless building control devices 14 with the respective enrolled first level wireless building control device 14 as an enrolled second level wireless building control device 14 in the routing table 16 maintained by the gateway device 12.

In some cases, the gateway device 12 may be configured to send a discover command to each of the enrolled second level wireless building control devices 14. The discover command causes each of the enrolled second level wireless building control devices 14 to wirelessly broadcast a discover building control device request. Each of the plurality of wireless building control devices 14 that are within wireless range of a respective enrolled second level wireless building control device 14 are configured to receive the discover building control device request, and in response, transmit a response message back to the respective enrolled second level wireless building control device 14. The respective enrolled second level wireless building control device 14 may be configured to receive the response message transmitted by each of the plurality of wireless building control devices 14 that are within wireless range of the respective enrolled second level wireless building control device 14. The respective enrolled second level wireless building control device 14 may be configured to determine which of the response messages transmitted by each of the plurality of wireless building control devices 14 indicate a device 14 and the respective wireless building control device 14 that meets third predetermined communication path criteria. The respective enrolled second level wireless building control device 14 may be configured to automatically enroll each of the one or more of the plurality of wireless building control devices 14 that transmitted a response message that indicates the communication path between the respective enrolled second level wireless building control device 14 and the respective wireless building control device 14 meets the second predetermined communication path criteria. The gateway device 12 may be configured to record the enrollment of the each of the one or more of the plurality of wireless building control devices 14 with the respective enrolled second level wireless building control device 14 as an enrolled third level wireless building control device 14 in the routing table 16 maintained by the gateway device 12.

More generally, the gateway device 12 may be configured to send a discover command to each of enrolled Nth level wireless building control devices 14, wherein the discover command causes each of the enrolled Nth level wireless building control devices 14 to wirelessly broadcast a discover building control device request, where N is an integer greater than 1. Each of the plurality of wireless building control devices 14 that are within wireless range of a respective enrolled Nth level wireless building control device 14 is configured to receive the discover building control device request, and in response, transmit a response message back to the respective enrolled Nth level wireless building control device 14. The respective enrolled Nth level wireless building control device 14 is configured to receive the response message transmitted by each of the plurality of wireless building control devices 14 that are within wireless range of the respective enrolled Nth level wireless building control device 14. The respective enrolled Nth level wireless building control device 14 may be configured to determine which of the response messages transmitted by each of the plurality of wireless building control devices 14 indicate a communication path between the respective enrolled Nth level wireless building control device 14 and the respective wireless building control device 14 that meets an N+1th predetermined communication path criteria. The respective enrolled Nth level wireless building control device 14 may be configured to automatically enroll each of the one or more of the plurality of wireless building control devices 14 that transmitted a response message that indicates the communication path between the respective enrolled Nth level wireless building control device 14 and the respective wireless building control device 14 meets the N+1th predetermined communication path criteria. The gateway device 12 may be configured to record the enrollment of the each of the one or more of the plurality of wireless building control devices 14 with the respective enrolled Nth level wireless building control device as enrolled N+1th level wireless building control device 14 in the routing table 16 maintained by the gateway device 12. The gateway device 12 may be configured to increment N and repeat until no more of the plurality of wireless building control devices 14 are discovered.

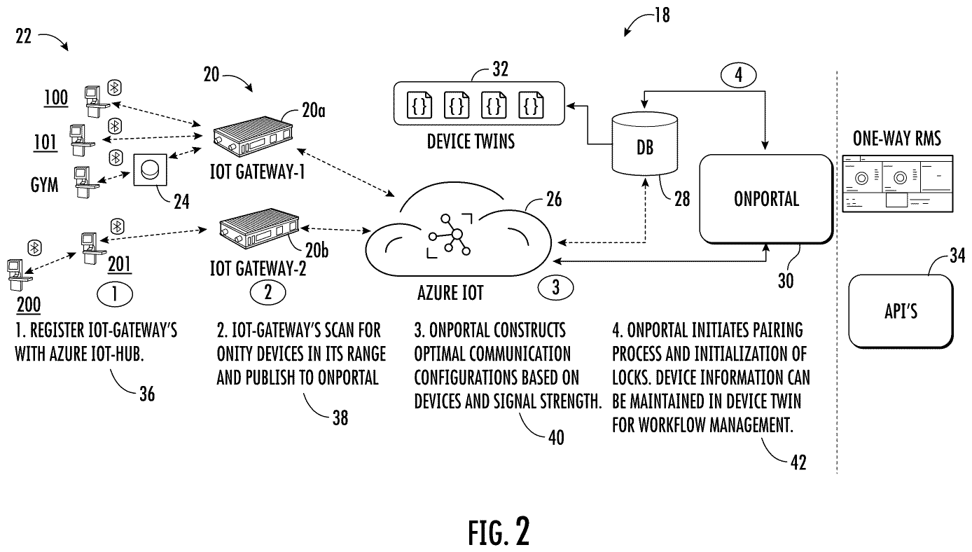

FIG. 2 is a schematic block diagram showing an illustrative workflow within an illustrative system 18. In some cases, the system 18 may be an example of the system 10. The system 18 includes a number of gateways 20 individually labeled as 20a and 20b that are installed within a property (such as a hotel). While only two gateways 20 are shown, the system 18 may include any number of gateways 20. Each of the gateways 20 may be equipped with a Bluetooth interface, a WiFi interface, an Ethernet interface, and/or a cellular interface. A number of wireless devices 22 are installed in the property. As an example, the wireless devices 22 may include door locks. Some of the wireless devices 22 are intended to be paired with the gateway 20a and some of the wireless devices 22 are intended to be paired with the gateway 20b, based on location of the wireless devices 22 relative to each of the gateways 20. For example, in some cases, it may be desirable for the wireless devices 22 that are located on a first floor of the property to be paired with gateway 20a and the wireless devices 22 that are located on a second floor of the property to be paired with gateway 20b. In any event, the wireless devices 22 labeled as 100, 101, and GY M are intended to be paired with the gateway 20a and the devices labeled 200 and 201 are intended to be paired with the gateway 20b. The wireless device 22 labeled GY M utilizes a repeater 24 to communicate with the gateway 20a. The wireless device 22 labeled as 200 communicates with the device labeled as 201, which itself communicates with the gateway 20b. The wireless device 22 labeled as 201 may be considered as being a first level device while the wireless device 22 labeled as 200 may be considered as being a second level device. The gateways 20 communicate with an IOT hub 26. The IOT hub 26 is coupled with a database 28 and an OnPortal™ supervisor 30. Device twins 32 may receive information from the database 28 and assembly a digital twin of the mesh network. The device twins 32 may allow an installer to view the mesh network of all enrolled devices (and in some cases make changes) via the OnPortal™ supervisor 30. The system 18 may communicates with API's 34 allowing remote access of certain data.

In the example shown, the gateways 20 are registered with the IOT hub 26, as indicated at block 36. As indicated above, the IOT hub 26 may be located in the cloud. The IOT hub 26 may command each of the gateways 20 to scan for wireless devices 22 that are within its wireless range, and publish this information back to the IOT hub 26 and to the OnPortal™ supervisor 30, as indicated at block 38. This may include validating and authenticating serial numbers, for example, against a design specification for the system 18. In some cases, the OnPortal™ supervisor 30 constructs optimal communication configurations based on devices and signal strength, as indicated at block 40. The OnPortal™ supervisor 30, the IOT Hub 26 and/or the gateways 20 may initiate a pairing and/or enrolling process. The collected device information is replicated within the device twins 32, as indicated at block 42.

Table 1 below provides an example of the communication paths that may form between the gateways 20 and the wireless building control devices 22.

TABLE 1

| Room Numbers | Primary Edge | Alternate Path |
|---|---|---|
| 101 | Gateway 1 | |
| 102 | Gateway 1 | |
| 103 | Gateway 1 | |
| 104 | Gateway 1 | 101 |
| 105 | 101 | |
| 106 | 102 | |
| 107 | 103 | 102 |
| 108 | 103 | 201 |
| 201 | Gateway 2 | |
| 202 | Gateway 2 | |
| 203 | Gateway 2 | |
| 204 | 201 | |
| 205 | 201 | 202 |
| 206 | 202 | |
| 207 | 202 | 203 |
| 208 | 203 | |

In this example, there are room numbers 101, 102, 103, 104, 105, 106, 107, and 108 on a first floor and room numbers 201, 202, 203, 204, 205, 206, 207, and 208 on a second floor. A Gateway 1 is intended to communicate with the wireless devices 22 in the first floor rooms and a Gateway 2 is intended to communicate with the wireless devices 22 in the second floor rooms. Starting with the first floor, as can be seen, the wireless building control devices 22 within each of room numbers 101, 102, 103, and 104 establish a good communication path directly with the Gateway 1. The wireless building control device within room number 105 establishes a good communication path with the wireless building control device in room number 101. The wireless building control device in room number 106 establishes a good communication path with the wireless building control device in room number 102. For the wireless building control devices in room numbers 107 and 108, each device establishes a good communication path with the wireless building control devices in room 103. The wireless building control device in room number 107 also establishes communication with the wireless building control device in room number 102, meaning that the wireless building control device in room number 102 provides an alternative communication path for the wireless building control device in room number 107. The wireless building control device in room number 108 also establishes communication with the wireless building control device in room number 201, meaning that the wireless building control device in room number 201 provides an alternative communication path for the wireless building control device in room number 209.

Looking at the second floor, as can be seen, the wireless building control devices within each of room numbers 201, 202, and 203 establish a good communication path directly with the Gateway 2. The wireless building control device within room number 204 establishes a good communication path with the wireless building control device in room number 201. The wireless building control device within room number 205 establishes a good communication path with the wireless building control device in room number 201. The wireless building control device in room number 205 also establishes a good communication path with the wireless building control device in room number 202, thereby providing an alternate path. The wireless building control devices in room number 206 establishes a good communication path with the wireless building control device in room number 202. The wireless building control device in room number 207 establishes a good communication path with the wireless building control device in room number 202. The wireless building control device in room number 207 also establishes a good communication path with the wireless building control device in room number 203, thereby providing an alternate path. The wireless building control devices in room number 208 establishes a good communication path with the wireless building control device in room number 203. The wireless building control devices in room numbers 101, 102, 103, 104, 201, 202, 203 may each be considered as being first level wireless building control devices as they communicate directly with a corresponding gateway. The wireless building control devices in room numbers 105, 106, 107, 108, 204, 205, 206, 207, and 208 may each be considered as being second level wireless building control devices as they communicate indirectly with the corresponding gateway through another wireless building control device.

The association between the various wireless devices in the various rooms and the corresponding gateways, such as expressed in Table 1, may be recorded in a routing table in each of the corresponding gateways. The routing tables may be communicated from the respective gateways to the IOT hub 26, the database 28, the Device Twins 32 and/or the OnPortal™ Supervisor 30 to communicate the overall architecture of the system 18 as it is automatically provisioned.

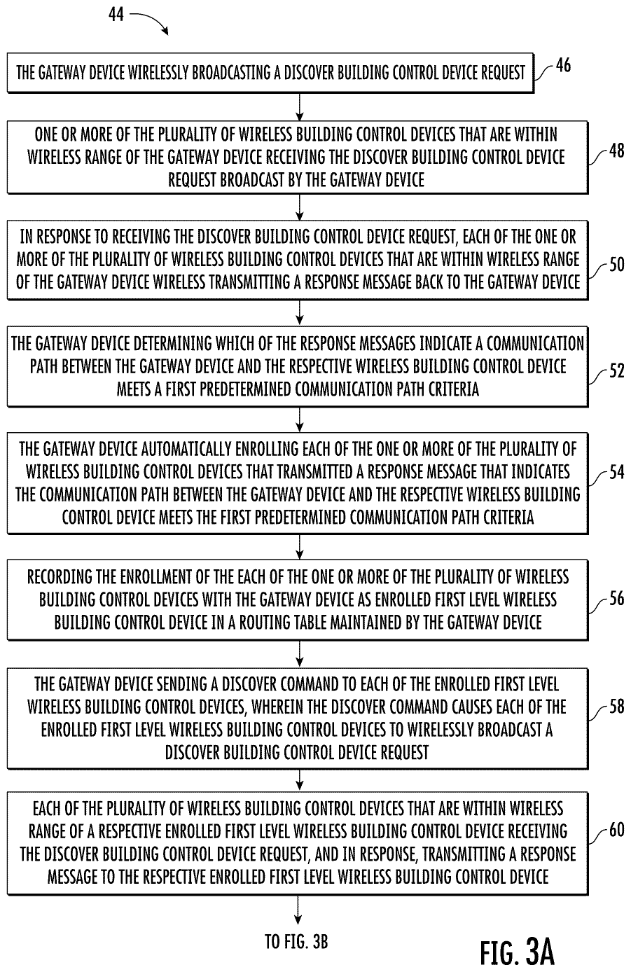

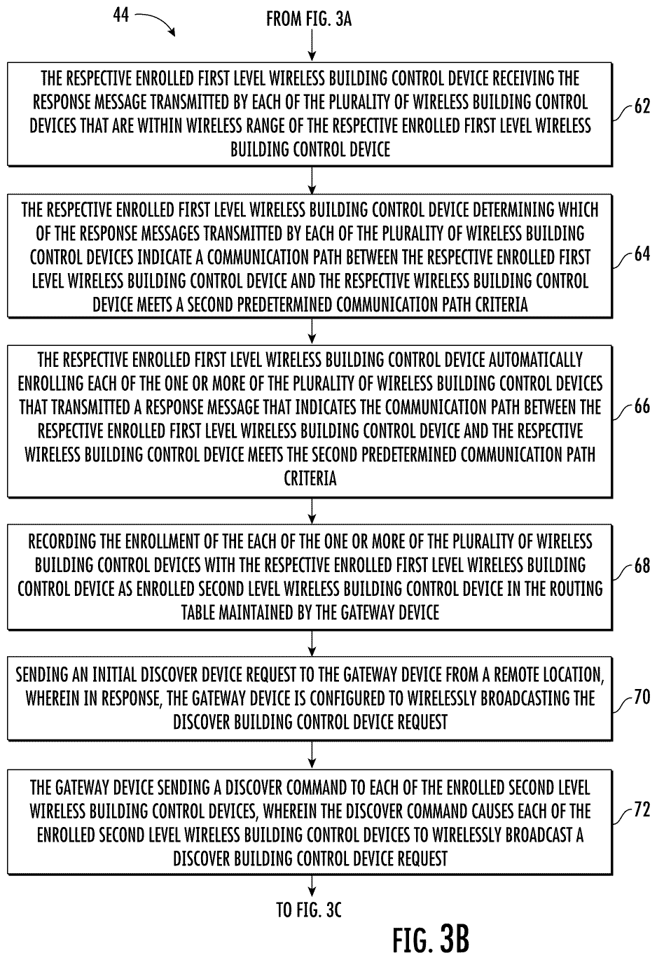

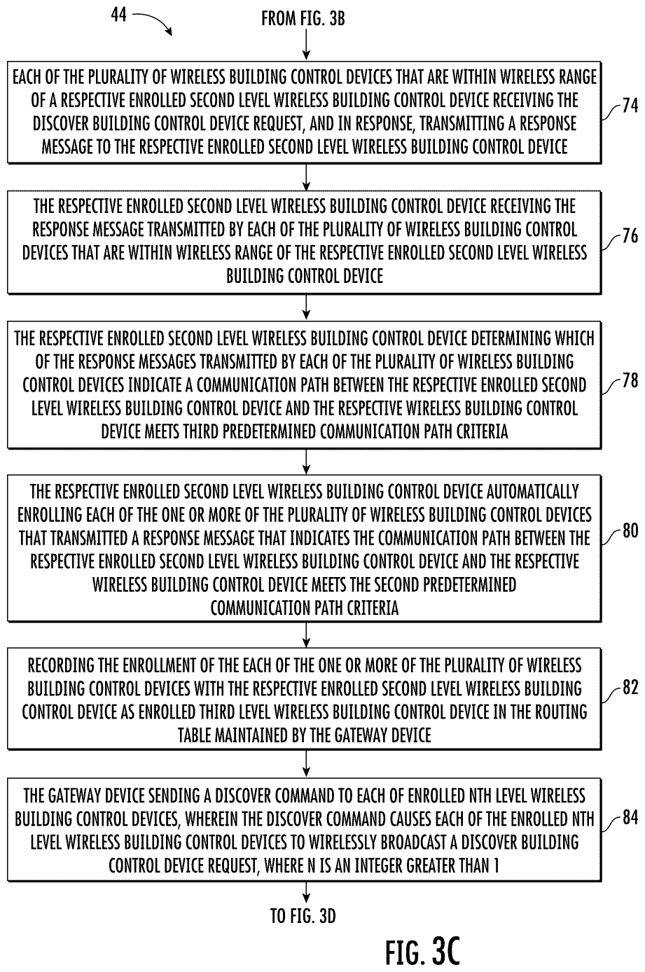

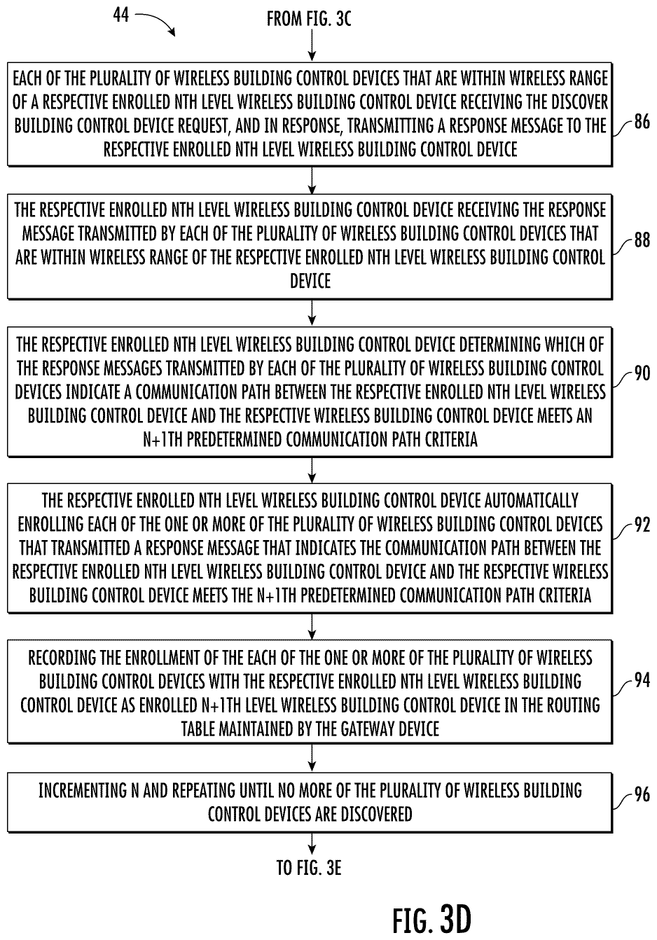

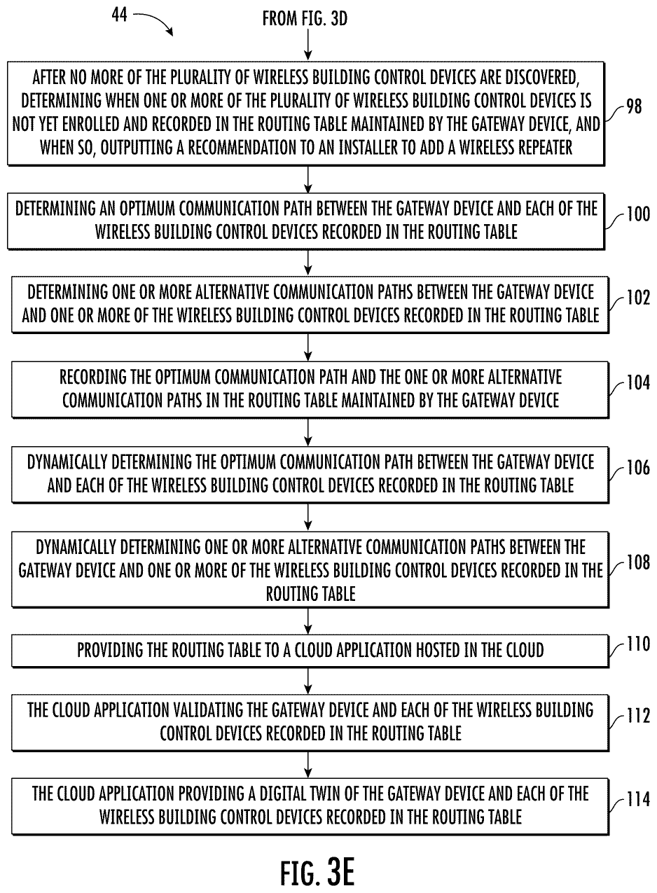

FIGS. 3A, 3B, 3C, 3D, and 3E are flow diagrams that together show an illustrative method 44 for provisioning a gateway device (such as the gateway device 12) of a building control system (such as the system 10) to communicate with a plurality of wireless building control devices (such as the wireless building control devices 14) over a wireless mesh network. The plurality of wireless building control devices may include one or more of a wireless door lock, a wireless repeater, a card reader, a wireless thermostat, a sensor such as temperature sensors, a humidity sensor, a motion sensor, a glass break sensor, a smoke sensor, a microphone and/or any other suitable building control device. The illustrative method 44 includes the gateway device wirelessly broadcasting a discover building control device request, as indicated at block 46. This may be in response to a request from the IOT hub 26 and/or OnPortal™ Supervisor 30.

One or more of the plurality of wireless building control devices that are within wireless range of the gateway device receive the discover building control device request broadcast by the gateway device, as indicated at block 48. In response to receiving the discover building control device request, each of the one or more of the plurality of wireless building control devices that are within wireless range of the gateway device wireless transmit a response message back to the gateway device, as indicated at block 50. The gateway device determines which of the response messages indicate a communication path between the gateway device and the respective wireless building control device that meets a first predetermined communication path criteria, as indicated at block 52. The gateway device automatically enrolls each of the one or more of the plurality of wireless building control devices that transmitted a response message that indicates the communication path between the gateway device and the respective wireless building control device meets the first predetermined communication path criteria, as indicated at block 54. The enrollment of the each of the one or more of the plurality of wireless building control devices is recorded with the gateway device as enrolled first level wireless building control device in a routing table (such as the routing table 16) maintained by the gateway device, as indicated at block 56. The gateway device then sends a discover command to each of the enrolled first level wireless building control devices, wherein the discover command causes each of the enrolled first level wireless building control devices to wirelessly broadcast a discover building control device request, as indicated at block 58. Each of the plurality of wireless building control devices that are within wireless range of a respective enrolled first level wireless building control device receive the discover building control device request, and in response, transmit a response message to the respective enrolled first level wireless building control device, as indicated at block 60.

Continuing on FIG. 3B, the respective enrolled first level wireless building control device receives the response message transmitted by each of the plurality of wireless building control devices that are within wireless range of the respective enrolled first level wireless building control device, as indicated at block 62. The respective enrolled first level wireless building control device determines which of the response messages transmitted by each of the plurality of wireless building control devices indicate a communication path between the respective enrolled first level wireless building control device and the respective wireless building control device that meets a second predetermined communication path criteria, as indicated at block 64. The respective enrolled first level wireless building control device automatically enrolls each of the one or more of the plurality of wireless building control devices that transmitted a response message that indicates the communication path between the respective enrolled first level wireless building control device and the respective wireless building control device meets the second predetermined communication path criteria, as indicated at block 66. The enrollment of the each of the one or more of the plurality of wireless building control devices is recorded with the respective enrolled first level wireless building control device as enrolled second level wireless building control device in the routing table maintained by the gateway device, as indicated at block 68. In some cases, the first predetermined communication path criteria and the second predetermined communication path criteria may be the same. In some cases, the first predetermined communication path criteria includes a Received Signal Strength Indicator (RSSI) that is above a first signal strength threshold. In some cases, the first predetermined communication path criteria includes a message transmit time of less than a first transit time threshold. In some cases, the first predetermined communication path criteria includes a hop count below a hop count threshold. In some cases, the first predetermined communication path criteria may include an angle of arrival of a wireless signal corresponding to the response message.

In some cases, the method 44 may include sending an initial discover device request to the gateway device from a remote location (e.g. the IOT hub 26 and/or OnPortal™ Supervisor 30), wherein in response, the gateway device may be configured to wirelessly broadcast the discover building control device request, as indicated at block 70. In some cases, the method 44 may include the gateway device sending a discover command to each of the enrolled second level wireless building control devices, wherein the discover command causes each of the enrolled second level wireless building control devices to wirelessly broadcast a discover building control device request, as indicated at block 72. Continuing on FIG. 3C, each of the plurality of wireless building control devices that are within wireless range of a respective enrolled second level wireless building control device may receive the discover building control device request, and in response, transmit a response message to the respective enrolled second level wireless building control device, as indicated at block 74. The respective enrolled second level wireless building control device receives the response message transmitted by each of the plurality of wireless building control devices that are within wireless range of the respective enrolled second level wireless building control device, as indicated at block 76. The respective enrolled second level wireless building control device determines which of the response messages transmitted by each of the plurality of wireless building control devices indicate a communication path between the respective enrolled second level wireless building control device and the respective wireless building control device that meets third predetermined communication path criteria, as indicated at block 78. The respective enrolled second level wireless building control device automatically enrolls each of the one or more of the plurality of wireless building control devices that transmitted a response message that indicates the device and the respective wireless building control device meets the second predetermined communication path criteria, as indicated at block 80. The enrollment of the each of the one or more of the plurality of wireless building control devices is recorded with the respective enrolled second level wireless building control device as enrolled third level wireless building control device in the routing table maintained by the gateway device, as indicated at block 82. In some cases, the first predetermined communication path criteria, the second predetermined communication path criteria and the third predetermined communication path criteria may be the same, but this is not required.

More generally, the method 44 may include the gateway device sending a discover command to each of enrolled Nth level wireless building control devices, wherein the discover command causes each of the enrolled Nth level wireless building control devices to wirelessly broadcast a discover building control device request, where N is an integer greater than 1, as indicated at block 84. Continuing on FIG. 3D, each of the plurality of wireless building control devices that are within wireless range of a respective enrolled Nth level wireless building control device may receive the discover building control device request, and in response, may transmit a response message to the respective enrolled Nth level wireless building control device, as indicated at block 86. The respective enrolled Nth level wireless building control device receives the response message transmitted by each of the plurality of wireless building control devices that are within wireless range of the respective enrolled Nth level wireless building control device, as indicated at block 88. The respective enrolled Nth level wireless building control device determines which of the response messages transmitted by each of the plurality of wireless building control devices indicate a communication path between the respective enrolled Nth level wireless building control device and the respective wireless building control device that meets an N+1th predetermined communication path criteria, as indicated at block 90. The respective enrolled Nth level wireless building control device automatically enrolls each of the one or more of the plurality of wireless building control devices that transmitted a response message that indicates the communication path between the respective enrolled Nth level wireless building control device and the respective wireless building control device meets the N+1th predetermined communication path criteria, as indicated at block 92. The enrollment of the each of the one or more of the plurality of wireless building control devices is recorded with the respective enrolled Nth level wireless building control device as enrolled N+1th level wireless building control device in the routing table maintained by the gateway device, as indicated at block 94. The method 44 may include incrementing N and repeating in an iterative manner until no more of the plurality of wireless building control devices are discovered, as indicated at block 96. Continuing on FIG. 3E, the method 44 may further include, after no more of the plurality of wireless building control devices are discovered, determining when one or more of the plurality of wireless building control devices is not yet enrolled and recorded in the routing table maintained by the gateway device, and when so, outputting a recommendation to an installer to, for example add a wireless repeater, as indicated at block 98.

In some cases, the method 44 may include determining an optimum communication path between the gateway device and each of the wireless building control devices recorded in the routing table, as indicated at block 100. One or more alternative communication paths between the gateway device and one or more of the wireless building control devices recorded in the routing table may be determined, as indicated at block 102. The optimum communication path and the one or more alternative communication paths are recorded in the routing table maintained by the gateway device, as indicated at block 104.

In some cases, the method 44 may include dynamically determining the optimum communication path between the gateway device and each of the wireless building control devices recorded in the routing table, as indicated at block 106. One or more alternative communication paths between the gateway device and one or more of the wireless building control devices recorded in the routing table are dynamically determined, as indicated at block 108. The optimum communication path and/or the one or more alternative communication paths may dynamically change over time based on dynamically changing predetermined communication path criteria, such as dynamically changing RSSI, message transmit time and message hop counts.

In some cases, the method 44 may include providing the routing table to a cloud application hosted in the cloud, as indicated at block 110. The cloud application may validate the gateway device and each of the wireless building control devices recorded in the routing table against a design specification of the system, as indicated at block 112. In some cases, the cloud application may provide a digital twin of the gateway device and each of the wireless building control devices recorded in the routing table, as indicated at block 114, which may facilitate viewing of the provisioned system via, for example, the OnPortal™ supervisor 30.

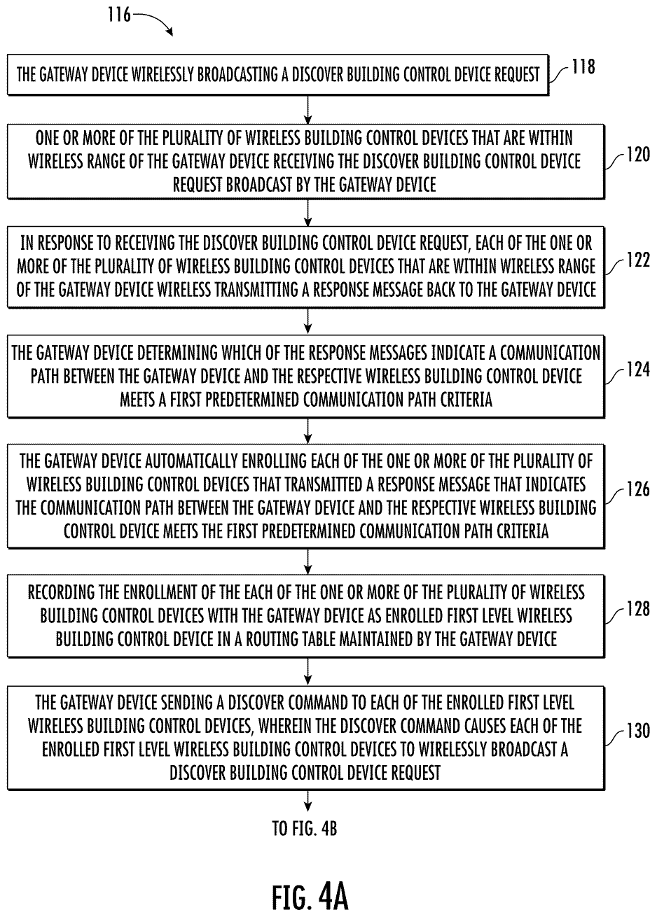

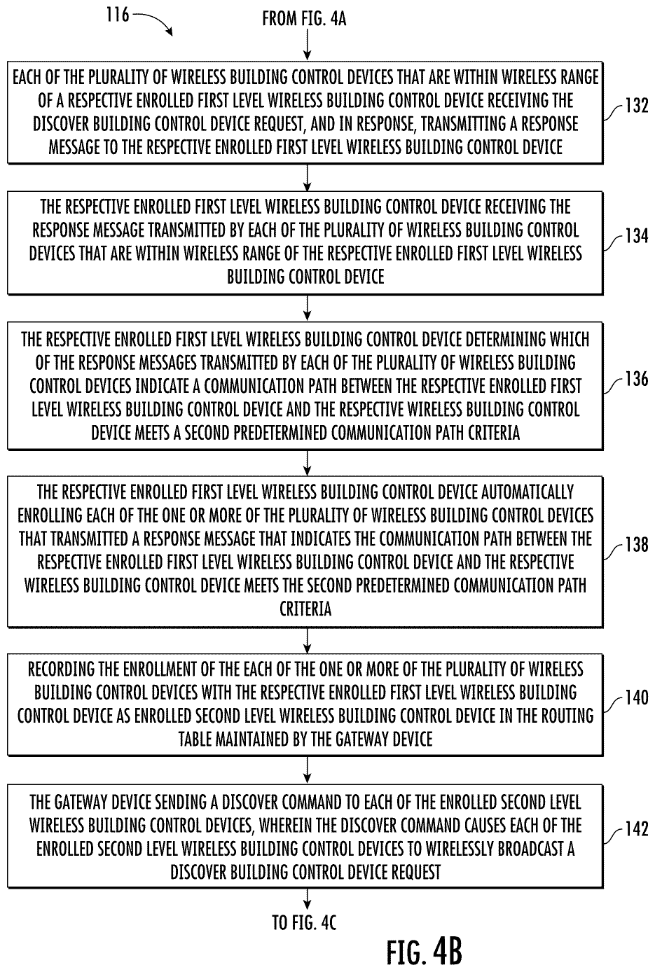

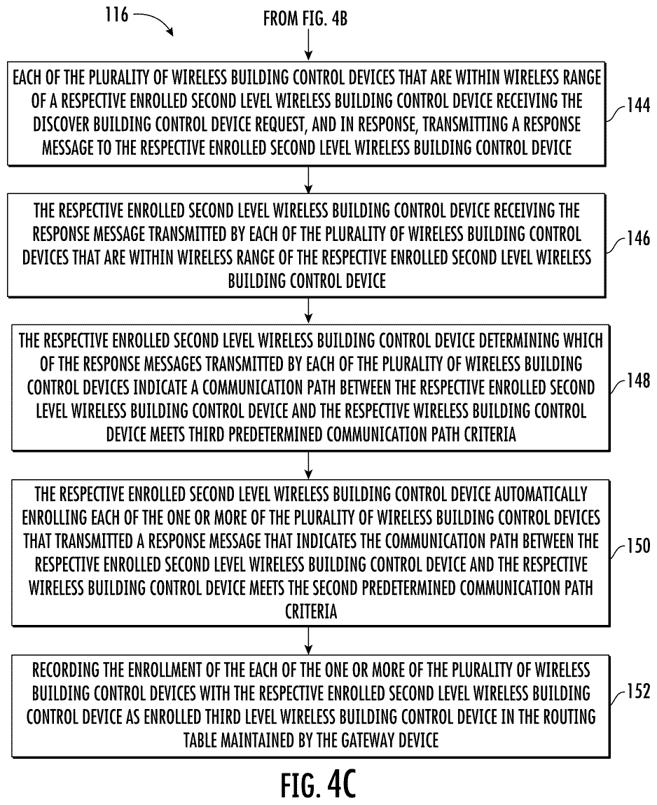

FIGS. 4A, 4B, and 4C are flow diagrams that together show an illustrative method 116 for provisioning a gateway device (such as the gateway device 12) of a building control system (such as the system 10) to communicate with a plurality of wireless building control devices (such as the wireless building control devices 14) over a wireless mesh network. The illustrative method 116 includes the gateway device wirelessly broadcasting a discover building control device request, as indicated at block 118. One or more of the plurality of wireless building control devices that are within wireless range of the gateway device receive the discover building control device request broadcast by the gateway device, as indicated at block 120. In response to receiving the discover building control device request, each of the one or more of the plurality of wireless building control devices that are within wireless range of the gateway device wireless transmit a response message back to the gateway device, as indicated at block 122. The gateway device determines which of the response messages indicate a communication path between the gateway device and the respective wireless building control device that meets a first predetermined communication path criteria, as indicated at block 124. The gateway device automatically enrolls each of the one or more of the plurality of wireless building control devices that transmitted a response message that indicates the communication path between the gateway device and the respective wireless building control device meets the first predetermined communication path criteria, as indicated at block 126. The enrollment of the each of the one or more of the plurality of wireless building control devices is recorded with the gateway device as enrolled first level wireless building control device in a routing table maintained by the gateway device, as indicated at block 128.

In some cases, the method 116 may include the gateway device sending a discover command to each of the enrolled first level wireless building control devices, wherein the discover command causes each of the enrolled first level wireless building control devices to wirelessly broadcast a discover building control device request, as indicated at block 130. Continuing on FIG. 4B, each of the plurality of wireless building control devices that are within wireless range of a respective enrolled first level wireless building control device may receive the discover building control device request, and in response, may transmit a response message to the respective enrolled first level wireless building control device, as indicated at block 132. The respective enrolled first level wireless building control device receive the response message transmitted by each of the plurality of wireless building control devices that are within wireless range of the respective enrolled first level wireless building control device, as indicated at block 134. The respective enrolled first level wireless building control device determines which of the response messages transmitted by each of the plurality of wireless building control devices indicate a communication path between the respective enrolled first level wireless building control device and the respective wireless building control device that meets a second predetermined communication path criteria, as indicated at block 136. The respective enrolled first level wireless building control device automatically enrolls each of the one or more of the plurality of wireless building control devices that transmitted a response message that indicates the communication path between the respective enrolled first level wireless building control device and the respective wireless building control device meets the second predetermined communication path criteria, as indicated at block 138. The enrollment of the each of the one or more of the plurality of wireless building control devices is recorded with the respective enrolled first level wireless building control device as enrolled second level wireless building control device in the routing table maintained by the gateway device, as indicated at block 140.

In some cases, the method 116 may include the gateway device sending a discover command to each of the enrolled second level wireless building control devices, wherein the discover command causes each of the enrolled second level wireless building control devices to wirelessly broadcast a discover building control device request, as indicated at block 142. Continuing on FIG. 4C, each of the plurality of wireless building control devices that are within wireless range of a respective enrolled second level wireless building control device may receive the discover building control device request, and in response, may transmit a response message to the respective enrolled second level wireless building control device, as indicated at block 144. The respective enrolled second level wireless building control device receives the response message transmitted by each of the plurality of wireless building control devices that are within wireless range of the respective enrolled second level wireless building control device, as indicated at block 146. The respective enrolled second level wireless building control device determines which of the response messages transmitted by each of the plurality of wireless building control devices indicate a communication path between the respective enrolled second level wireless building control device and the respective wireless building control device that meets third predetermined communication path criteria, as indicated at block 148. The respective enrolled second level wireless building control device automatically enrolls each of the one or more of the plurality of wireless building control devices that transmitted a response message that indicates the communication path between the respective enrolled second level wireless building control device and the respective wireless building control device meets the second predetermined communication path criteria, as indicated at block 150. The enrollment of the each of the one or more of the plurality of wireless building control devices is recorded with the respective enrolled second level wireless building control device as enrolled third level wireless building control device in the routing table maintained by the gateway device, as indicated at block 152.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for provisioning a gateway device of a building control system to communicate with a plurality of wireless building control devices over a wireless mesh network, the method comprising:
the gateway device wirelessly broadcasting a discover building control device request;
one or more of the plurality of wireless building control devices that are within wireless range of the gateway device receiving the discover building control device request broadcast by the gateway device;
in response to receiving the discover building control device request, each of the one or more of the plurality of wireless building control devices that are within wireless range of the gateway device wireless transmitting a response message back to the gateway device;
the gateway device determining which of the response messages indicate a communication path between the gateway device and the respective wireless building control device that meets a first predetermined communication path criteria;
the gateway device automatically enrolling each of the one or more of the plurality of wireless building control devices that transmitted a response message that indicates the communication path between the gateway device and the respective wireless building control device meets the first predetermined communication path criteria;
recording the enrollment of the each of the one or more of the plurality of wireless building control devices with the gateway device as enrolled first level wireless building control device in a routing table maintained by the gateway device;
the gateway device sending a discover command to each of the enrolled first level wireless building control devices, wherein the discover command causes each of the enrolled first level wireless building control devices to wirelessly broadcast a discover building control device request;
each of the plurality of wireless building control devices that are within wireless range of a respective enrolled first level wireless building control device receiving the discover building control device request, and in response, transmitting a response message to the respective enrolled first level wireless building control device;
the respective enrolled first level wireless building control device receiving the response message transmitted by each of the plurality of wireless building control devices that are within wireless range of the respective enrolled first level wireless building control device;
the respective enrolled first level wireless building control device determining which of the response messages transmitted by each of the plurality of wireless building control devices indicate a communication path between the respective enrolled first level wireless building control device and the respective wireless building control device that meets a second predetermined communication path criteria;
the respective enrolled first level wireless building control device automatically enrolling each of the one or more of the plurality of wireless building control devices that transmitted a response message that indicates the communication path between the respective enrolled first level wireless building control device and the respective wireless building control device meets the second predetermined communication path criteria; and
recording the enrollment of the each of the one or more of the plurality of wireless building control devices with the respective enrolled first level wireless building control device as enrolled second level wireless building control device in the routing table maintained by the gateway device.

2. The method of claim 1, wherein the first predetermined communication path criteria and the second predetermined communication path criteria are the same.

3. The method of claim 1, wherein the first predetermined communication path criteria include one or more of:
a Received Signal Strength Indicator (R SSI) that is above a first signal strength threshold;
a message transmit time of less than a first transit time threshold; and
a hop count below a hop count threshold.

4. The method of claim 1, wherein the first predetermined communication path criteria includes an angle of arrival of a wireless signal corresponding to the response message.

5. The method of claim 1, comprising sending an initial discover device request to the gateway device from a remote location, wherein in response, the gateway device is configured to wirelessly broadcasting the discover building control device request.

6. The method of claim 1, further comprising:
the gateway device sending a discover command to each of the enrolled second level wireless building control devices, wherein the discover command causes each of the enrolled second level wireless building control devices to wirelessly broadcast a discover building control device request;
each of the plurality of wireless building control devices that are within wireless range of a respective enrolled second level wireless building control device receiving the discover building control device request, and in response, transmitting a response message to the respective enrolled second level wireless building control device;
the respective enrolled second level wireless building control device receiving the response message transmitted by each of the plurality of wireless building control devices that are within wireless range of the respective enrolled second level wireless building control device;
the respective enrolled second level wireless building control device determining which of the response messages transmitted by each of the plurality of wireless building control devices indicate a communication path between the respective enrolled second level wireless building control device and the respective wireless building control device that meets third predetermined communication path criteria;
the respective enrolled second level wireless building control device automatically enrolling each of the one or more of the plurality of wireless building control devices that transmitted a response message that indicates the communication path between the respective enrolled second level wireless building control device and the respective wireless building control device meets the second predetermined communication path criteria; and
recording the enrollment of the each of the one or more of the plurality of wireless building control devices with the respective enrolled second level wireless building control device as enrolled third level wireless building control device in the routing table maintained by the gateway device.

7. The method of claim 1, further comprising:
the gateway device sending a discover command to each of enrolled Nth level wireless building control devices, wherein the discover command causes each of the enrolled Nth level wireless building control devices to wirelessly broadcast a discover building control device request, where N is an integer greater than 1;
each of the plurality of wireless building control devices that are within wireless range of a respective enrolled Nth level wireless building control device receiving the discover building control device request, and in response, transmitting a response message to the respective enrolled Nth level wireless building control device;
the respective enrolled Nth level wireless building control device receiving the response message transmitted by each of the plurality of wireless building control devices that are within wireless range of the respective enrolled Nth level wireless building control device;
the respective enrolled Nth level wireless building control device determining which of the response messages transmitted by each of the plurality of wireless building control devices indicate a communication path between the respective enrolled Nth level wireless building control device and the respective wireless building control device that meets an N+1th predetermined communication path criteria;
the respective enrolled Nth level wireless building control device automatically enrolling each of the one or more of the plurality of wireless building control devices that transmitted a response message that indicates the communication path between the respective enrolled Nth level wireless building control device and the respective wireless building control device meets the N+1th predetermined communication path criteria;
recording the enrollment of the each of the one or more of the plurality of wireless building control devices with the respective enrolled Nth level wireless building control device as enrolled N+1th level wireless building control device in the routing table maintained by the gateway device; and
incrementing N and repeating until no more of the plurality of wireless building control devices are discovered.

8. The method of claim 7, wherein after no more of the plurality of wireless building control devices are discovered, determining when one or more of the plurality of wireless building control devices is not yet enrolled and recorded in the routing table maintained by the gateway device, and when so, outputting a recommendation to an installer to add a wireless repeater.

9. The method of claim 1, comprising:
determining an optimum communication path between the gateway device and each of the wireless building control devices recorded in the routing table;
determining one or more alternative communication paths between the gateway device and one or more of the wireless building control devices recorded in the routing table; and
recording the optimum communication path and the one or more alternative communication paths in the routing table maintained by the gateway device.

10. The method of claim 9, comprising:
dynamically determining the optimum communication path between the gateway device and each of the wireless building control devices recorded in the routing table; and
dynamically determining one or more alternative communication paths between the gateway device and one or more of the wireless building control devices recorded in the routing table.

11. The method of claim 1, wherein the plurality of wireless building control devices include one or more of a wireless door lock, a wireless repeater, a card reader, a wireless thermostat, a wireless controller and a wireless sensor.

12. The method of claim 1, comprising providing the routing table to a cloud application hosted in the cloud.

13. The method of claim 12, the cloud application validating the gateway device and each of the wireless building control devices recorded in the routing table.

14. The method of claim 12, the cloud application providing a digital twin of the gateway device and each of the wireless building control devices recorded in the routing table.

15. A building control system comprising:
a gateway device;
a plurality of wireless building control devices;
wherein gateway device is configured to broadcast a discover building control device request;
each of one or more of the plurality of wireless building control devices that are within wireless range of the gateway device are configured to receive the discover building control device request broadcast by the gateway device;
in response to receiving the discover building control device request, each of the one or more of the plurality of wireless building control devices that are within wireless range of the gateway device wireless are configured to transmit a response message back to the gateway device;
the gateway device is configured to determine which of the response messages indicate a communication path between the gateway device and the respective wireless building control device that meets a first predetermined communication path criteria;
the gateway device is configured to automatically enroll each of the one or more of the plurality of wireless building control devices that transmitted a response message that indicates the communication path between the gateway device and the respective wireless building control device meets the first predetermined communication path criteria;
the gateway device is configured to record the enrollment of the each of the one or more of the plurality of wireless building control devices with the gateway device as enrolled first level wireless building control device in a routing table maintained by the gateway device;
the gateway device is configured to send a discover command to each of the enrolled first level wireless building control devices, wherein the discover command causes each of the enrolled first level wireless building control devices to wirelessly broadcast a discover building control device request;
each of the plurality of wireless building control devices that are within wireless range of a respective enrolled first level wireless building control device are configured to receive the discover building control device request, and in response, transmit a response message to the respective enrolled first level wireless building control device;
the respective enrolled first level wireless building control device is configured to receive the response message transmitted by each of the plurality of wireless building control devices that are within wireless range of the respective enrolled first level wireless building control device;
the respective enrolled first level wireless building control device is configured to determine which of the response messages transmitted by each of the plurality of wireless building control devices indicate a communication path between the respective enrolled first level wireless building control device and the respective wireless building control device that meets a second predetermined communication path criteria;
the respective enrolled first level wireless building control device is configured to automatically enroll each of the one or more of the plurality of wireless building control devices that transmitted a response message that indicates the communication path between the respective enrolled first level wireless building control device and the respective wireless building control device meets the second predetermined communication path criteria; and
the gateway device is configured to record the enrollment of the each of the one or more of the plurality of wireless building control devices with the respective enrolled first level wireless building control device as enrolled second level wireless building control device in the routing table maintained by the gateway device.

16. The building control system of claim 15, wherein
the gateway device is configured to send a discover command to each of the enrolled second level wireless building control devices, wherein the discover command causes each of the enrolled second level wireless building control devices to wirelessly broadcast a discover building control device request;
each of the plurality of wireless building control devices that are within wireless range of a respective enrolled second level wireless building control device are configured to receive the discover building control device request, and in response, transmit a response message to the respective enrolled second level wireless building control device;
the respective enrolled second level wireless building control device is configured to receive the response message transmitted by each of the plurality of wireless building control devices that are within wireless range of the respective enrolled second level wireless building control device;
the respective enrolled second level wireless building control device is configured to determine which of the response messages transmitted by each of the plurality of wireless building control devices indicate a communication path between the respective enrolled second level wireless building control device and the respective wireless building control device that meets third predetermined communication path criteria;
the respective enrolled second level wireless building control device is configured to automatically enroll each of the one or more of the plurality of wireless building control devices that transmitted a response message that indicates the communication path between the respective enrolled second level wireless building control device and the respective wireless building control device meets the second predetermined communication path criteria; and
the gateway device is configured to record the enrollment of the each of the one or more of the plurality of wireless building control devices with the respective enrolled second level wireless building control device as enrolled third level wireless building control device in the routing table maintained by the gateway device.

17. The building control system of claim 15, wherein:
the gateway device is configured to send a discover command to each of enrolled Nth level wireless building control devices, wherein the discover command causes each of the enrolled Nth level wireless building control devices to wirelessly broadcast a discover building control device request, where N is an integer greater than 1;
each of the plurality of wireless building control devices that are within wireless range of a respective enrolled Nth level wireless building control device is configured to receive the discover building control device request, and in response, transmit a response message to the respective enrolled Nth level wireless building control device;
the respective enrolled Nth level wireless building control device is configured to receive the response message transmitted by each of the plurality of wireless building control devices that are within wireless range of the respective enrolled Nth level wireless building control device;
the respective enrolled Nth level wireless building control device is configured to determine which of the response messages transmitted by each of the plurality of wireless building control devices indicate a communication path between the respective enrolled Nth level wireless building control device and the respective wireless building control device that meets an N+1th predetermined communication path criteria;
the respective enrolled Nth level wireless building control device is configured to automatically enroll each of the one or more of the plurality of wireless building control devices that transmitted a response message that indicates the communication path between the respective enrolled Nth level wireless building control device and the respective wireless building control device meets the N+1th predetermined communication path criteria;
the gateway device is configured to record the enrollment of the each of the one or more of the plurality of wireless building control devices with the respective enrolled Nth level wireless building control device as enrolled N+1th level wireless building control device in the routing table maintained by the gateway device; and
the gateway device is configured to increment N and repeat until no more of the plurality of wireless building control devices are discovered.

18. A method for provisioning a gateway device of a building control system to communicate with a plurality of wireless building control devices over a wireless mesh network, the method comprising:
the gateway device wirelessly broadcasting a discover building control device request;
one or more of the plurality of wireless building control devices that are within wireless range of the gateway device receiving the discover building control device request broadcast by the gateway device;
in response to receiving the discover building control device request, each of the one or more of the plurality of wireless building control devices that are within wireless range of the gateway device wireless transmitting a response message back to the gateway device;
the gateway device determining which of the response messages indicate a communication path between the gateway device and the respective wireless building control device that meets a first predetermined communication path criteria;
the gateway device automatically enrolling each of the one or more of the plurality of wireless building control devices that transmitted a response message that indicates the communication path between the gateway device and the respective wireless building control device meets the first predetermined communication path criteria; and
recording the enrollment of the each of the one or more of the plurality of wireless building control devices with the gateway device as enrolled first level wireless building control device in a routing table maintained by the gateway device.

19. The method of claim 18, further comprising:
the gateway device sending a discover command to each of the enrolled first level wireless building control devices, wherein the discover command causes each of the enrolled first level wireless building control devices to wirelessly broadcast a discover building control device request;
each of the plurality of wireless building control devices that are within wireless range of a respective enrolled first level wireless building control device receiving the discover building control device request, and in response, transmitting a response message to the respective enrolled first level wireless building control device;
the respective enrolled first level wireless building control device receiving the response message transmitted by each of the plurality of wireless building control devices that are within wireless range of the respective enrolled first level wireless building control device;
the respective enrolled first level wireless building control device determining which of the response messages transmitted by each of the plurality of wireless building control devices indicate a communication path between the respective enrolled first level wireless building control device and the respective wireless building control device that meets a second predetermined communication path criteria;
the respective enrolled first level wireless building control device automatically enrolling each of the one or more of the plurality of wireless building control devices that transmitted a response message that indicates the communication path between the respective enrolled first level wireless building control device and the respective wireless building control device meets the second predetermined communication path criteria; and
recording the enrollment of the each of the one or more of the plurality of wireless building control devices with the respective enrolled first level wireless building control device as enrolled second level wireless building control device in the routing table maintained by the gateway device.

20. The method of claim 19, further comprising:
the gateway device sending a discover command to each of the enrolled second level wireless building control devices, wherein the discover command causes each of the enrolled second level wireless building control devices to wirelessly broadcast a discover building control device request;
each of the plurality of wireless building control devices that are within wireless range of a respective enrolled second level wireless building control device receiving the discover building control device request, and in response, transmitting a response message to the respective enrolled second level wireless building control device;
the respective enrolled second level wireless building control device receiving the response message transmitted by each of the plurality of wireless building control devices that are within wireless range of the respective enrolled second level wireless building control device;
the respective enrolled second level wireless building control device determining which of the response messages transmitted by each of the plurality of wireless building control devices indicate a communication path between the respective enrolled second level wireless building control device and the respective wireless building control device that meets third predetermined communication path criteria;
the respective enrolled second level wireless building control device automatically enrolling each of the one or more of the plurality of wireless building control devices that transmitted a response message that indicates the communication path between the respective enrolled second level wireless building control device and the respective wireless building control device meets the second predetermined communication path criteria; and
recording the enrollment of the each of the one or more of the plurality of wireless building control devices with the respective enrolled second level wireless building control device as enrolled third level wireless building control device in the routing table maintained by the gateway device.
